(19) United States
(12) Patent Application Publication
(10) Pub. No.: US 2020/0110597 A1
(43) Pub. Date: Apr. 9, 2020

(54) SYSTEM AND METHOD FOR AUTHORING A SOFTWARE APPLICATION

(71) Applicant: Cigna Intellectual Property, Inc., Philadephia, PA (US)

(72) Inventor: Christopher Comer, Erie, CO (US)

(21) Appl. No.: 16/153,343

(22) Filed: Oct. 5, 2018

(51) Int. Cl. G06F 8/71; G06F 8/65; G06F 8/36

(52) U.S. Cl. CPC G06F 8/71; G06F 8/36; G06F 8/65

(57) ABSTRACT

A system for authoring a software application includes an application codebase that has an application class extension, an activity class extension, a theme, and a module class. The application codebase is used to generate a software module to be incorporated into the software application. The software module extends the module class, the software application includes at least one activity, and the software application specifies the application class extension that is common to the software module. The software application specifies the theme, and the activity of the software application extends the activity class extension.

### BACKGROUND

Companies often develop software applications for customers to use. Within a company, each software application may be written by a different team, even if there is similar functionality within each application. This may lead to different codebases being designed and used for the applications, repetition of efforts, and the need to maintain each application separately.

### BRIEF DESCRIPTION OF THE DRAWINGS

FIG. 1A is a block diagram of a system for generating a software application, according to an embodiment of the present invention;

FIG. 1B is a block diagram of the actors involved in the system of FIG. 1A, according to an embodiment of the present invention;

FIGS. 2A-2D are flowcharts illustrating how to create a consumable module, according to an embodiment of the present invention;

FIG. 3 is a flowchart illustrating the operations used to generate a software application, according to an embodiment of the present invention; and

FIG. 4A is another flowchart illustrating the operations used to generate a software application, according to an embodiment of the present invention; and

FIGS. 4B and 4C are more detailed flowcharts related to FIG. 4A illustrating the operations used to generate a software application, according to embodiments of the present invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

In the scenario described above, the different teams may develop custom or single-use code. Alternatively, one team may develop a module and recognize that it may be used by other teams, so the module may be cloned to be used in other applications. The module may present identical (or nearly identical) experiences to an application end-user, such as a customer, but each application is an entirely separate project and codebase, each of which must be updated, maintained, and tested independently.

The inventor has developed a framework or a platform for writing software applications (“apps”). The framework includes a single application codebase, which is used to generate software modules, which are then used to make the app. More than one application may use each software module, but the software module is not cloned for each app. Instead, the author or owner of the software application takes certain steps to incorporate the application codebase into the software application. Thus, when a change needs to be made to the module, the module developer modifies that module once, and the change is distributed to each application that uses the module. In practice, the module developer updates and releases a new version of that module to a content repository such as Maven. Then, application owners/authors may update their apps to the latest version of the module to consume the changes. Apps can also choose to remain on specific/older versions depending on their use case.

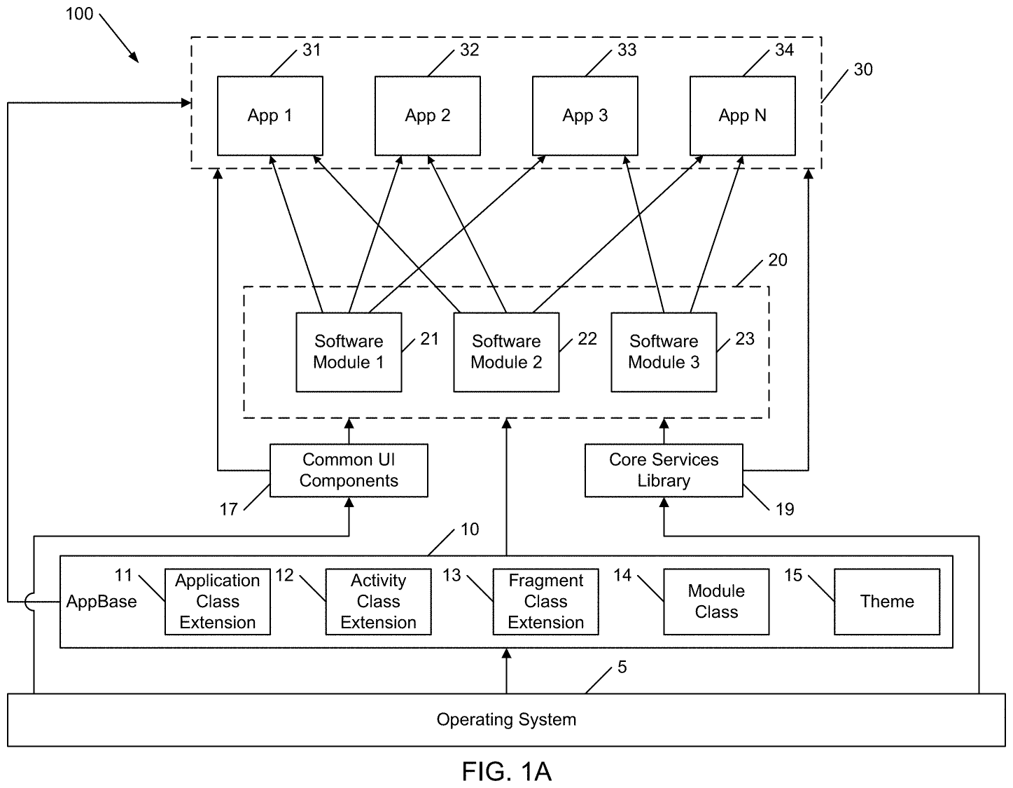

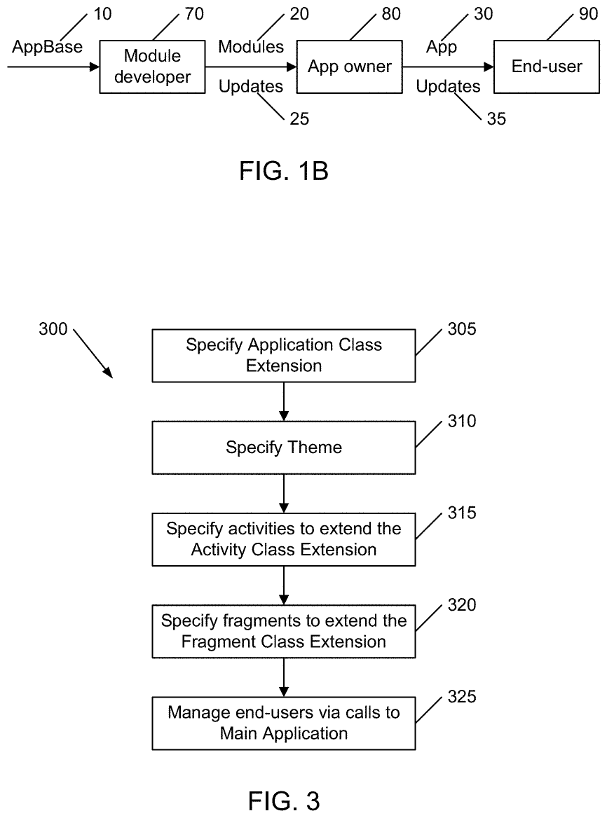

Reference is now made to FIG. 1A, which is a block diagram of a system 100 for generating a software application, according to an embodiment of the present invention. System 100 includes AppBase (or “application codebase”) 10, software modules 20, common user interface (UI) components 17, and core services library 19. Broadly, AppBase 10 is used to generate one or more software modules 21-23 with the help of common UI components 17 and core services library 19. Access to each software module is then included in the code for two or more software applications 30 (of which only 4 are shown), which share the module and its functionality. Software applications 30 may be any type of software program generally intended for use by an end-user, and include what are colloquially called “apps,” which are used on smartphones, tablets, and other mobile devices. Software applications 30 are not, however, limited to “apps” or to use on mobile devices, and may be deployed on any type of desktop, laptop, or other computer. Software applications 30 may pull in and use the core services and common UI components and may use any combination of software modules without requiring separate configuration.

Reference is now made to FIG. 1B, which is a block diagram of the actors involved in the system of FIG. 1A, according to an embodiment of the present invention. Module developer 70 uses AppBase 10 to generate or produce modules 20, which are consumed by app owner 80. App owner 80 generates app 30 and provides it to end-user 90. Module developer 70 also generates or produces updates 25 to modules 20, which may be incorporated into app 30 by app owner 80. Subsequently, end-user 90 may update app 30 with updates 35 provided by app owner 80.

One embodiment of the invention may be implemented using the Android operating system (which in turn is built on the Java programming language), which will be used to illustrate aspects of the invention. AppBase 10, implemented using operating system 5, includes extensions to the Android standard base classes of Application, Activity, and Fragment, a Module class, and a Theme, which provide common functionality. “Class” is a Java term representing a file of code. An “activity” may be a screen presented to an end-user, and a single activity may present multiple “fragments” to the end-user. These fragments may be independent of each other or may share data via the activity. Thus, every screen an end-user sees in an Android application is either an activity or a fragment, and they are all held together by the application class. A Theme is a collection of color, image, and size resource values that will be applied to the entire application. AppBase 10 extends (adds functionality to) the Application, Activity, and Fragment classes, and in order to use the AppBase framework/platform, each application and module must be built using the AppBase versions of these classes.

AppBase 10 supports design, development, and inclusion of software modules 20. In this embodiment, AppBase 10 includes Application Class Extension 11, Activity Class Extension 12, Fragment Class Extension 13, Module Class 14, and Theme 15. AppBase 10 may also include analytics code; “hockey” code, which is Microsoft® utility code that manages application releases and tracks issues in deployed code; common and system utilities; data storage; module interface definition; HTTP (global) request/response processing; and Android M (a version of the Android OS) permissions handling. (Compared to previous versions of the Android OS, Android M changed the way the system handles permissions (to access storage, camera, etc.). The permissions utility code makes it easier for app owners using AppBase 10 to leverage the new calls without concern for OS version or system limitations.)

AppBase 10 is used to create one or more software modules 20, which represent self-contained functionalities that are larger than a single “component” but smaller than an entire software application. A “component” in this context is a single item within a larger Activity or Fragment (i.e. screen/page). Modules are used to specify larger logical blocks such as complex calculations, a series of screens, or advanced data processing. These typically consist of many components working together. Modules are built on top of AppBase 10 and use a standard theming technique, so that when they are used in an application they do not appear out of place. Modules are highly configurable in that they can be customized to different applications, languages, themes, and/or storage methodologies. Modules are functional on their own, so they can be plugged (referenced/pulled-in via a build file and loaded via a single Initialize call at application boot) into any application built using AppBase 10 and operate without other considerations or requirements. Almost always, modules provide a series of configurations so that applications can customize their behavior, but the default values will result in a valid functional experience. Modules are independent of each other, are application agnostic, and provide interfaces and callbacks so that applications can inject alternate or app-specific data as required. Specific modules (such as those that connect to distinct application programming interfaces (APIs) or services) may include their own network handling. When a network is required, because, e.g., the module needs to retrieve data from some place other than the local device (i.e. a server), the module defines its own environment and specifies by key when making calls. Software applications are allowed to and are able to replace environment configurations at compile time.

Software modules 20 contain string resources for all supported languages—the software application itself should be written to lock the end-user into its desired regional support. In the Android OS, string resources typically comprise a file with all user-visible strings/sentences within it, and that file is referenced from the application code so that the application can display in a different language by changing the file reference. AppBase 10 may automatically lock the user into regional support (“locale locking”) using values within a configuration file (which may be named “config.xml”) that can be overridden by any application. Applications are able to add language support with varying results by providing additional translation files. For example, an application may support more languages than its modules do, in which case, the end-user would be presented with different languages in different sections of the application. (i.e., the main app can be written to support English, Spanish, and French, but if Module A supports only English and Spanish, and Module B supports only French, end-users set to those locales would see varying content as they navigate through the app.

One exemplary environment for embodiments of this invention is in generating “apps” for healthcare management. In such embodiments, there may be two types of software modules—functional and activity. A functional module provides reusable logic and methods, but does not define any UI or activities. Examples of functional modules are a “Core_Services” module and a “wearables” module. In an embodiment, a “Core_Services” module may perform, among other things, network services, environment/server definition, authentication handling, token and cookie management, and request/response processing. A Core_Services module will be discussed in more detail below. In an embodiment, a “wearables” module may integrate with wearable devices (e.g., Garmin®, Jawbone®) and may report to the application on the available data (e.g., step counts, etc.).

An activity module provides reusable logic (like a functional module), but also defines its own activities and UI, and sometimes its own navigational flow. Examples of activity modules are a “journal” module and a “programs” module. In an embodiment, a “journal” module may provide a record of an end-user's user experience (UX) and database, for accepting and storing a variety of user input locally on the device using the software application. Such a journal module may be capable of handling in-app deep links using configured keys. In an embodiment, a “programs” module may control, present, store, and allow interaction with a set of programs intended to guide end-users through some number of planned activities for specific purposes. Such a module may include service layer interaction for update and storage. One or more of these software modules may be configured using “JSON” (JavaScript Object Notation), which is a data-interchange format, or may interact with JSON-defined elements. Both of these activity modules may provide their own navigational flow by having a defined navigational path from A→Z, rather than a collection of single activities. These modules also allow apps to step in to the navigational flow at several points by providing specific information. A journal module, for example, may bring an end-user to a list of all entries, or to directly create a new entry of a certain type—each of these may have a specific navigation anchor presented to the end-user from the main application.

Examples of other software (activity) modules in this embodiment are “CRM Messaging,” “Click to Chat,” “Maps and Location,” “Telehealth,” “User Assessment,” “Library/Articles,” and “Directory.” “CRM Messaging” processes messages and UX, including connection points for application control of user actions. This module displays business promotions to the end-user, including a view pager and an “inbox.” “Click to Chat” allows an end-user to initiate and complete a Chat-with-an-agent session within a software application. “Maps and Location” controls and displays all map and location information to an end-user with a standardized interface across device types. “Telehealth” includes integrated video teleconference to consulting doctors, including scheduling and other functionality. “User Assessment” provides a JSON-configured series of questions that will result in distinct, calculated responses. “Library/Articles” is located on the presentation layer for JSON-configured series of articles, sourced either on the end-user's device or on a remote server. This module is capable of deep-linking directly to software applications or of handling in-app deep links using configured keys. “Directory” acts like the Yellow Pages for in-network medical services.

Core services library 19 may include presentation of a mobile APIs layer, data caching (session management), generic service request/response processing, environment switching and management, username+password and FIDO/fingerprint capabilities (“FIDO,” a touchID function, stands for “fast identity online”), and MFA capabilities, which may include token MFA, in which an end-user logs in and is sent a token to the end-user's e-mail address or cell phone for confirmation and subsequent input before being allowed to use the app. Core services library 19 may provide the networking backbone for Android applications developed using system 100, including WebSEAL and ISAM (IBM Security Access Manager) server platforms. It may support local data and other test environments. It may also allow concurrent connections to multiple servers, provided they use identical credentials. Core services library 19 may also include an HTTP connections layer.

Common UI components 17 may include individual components that provide more functionality than basic Android components, components created for any project that can be built and configured in a generic way, to promote reuse and uniformity across applications. Common UI components 17 may include components that support standard theming and may specify custom attributes as appropriate. Custom components may have standardized inputs, charts and graphs, and system extensions. Components may also promote debugging of the UI, may handle photo, video, and/or audio, and may include utilities such as bitmap management and style management.

In an embodiment, common UI components 17 contains a single Android Studio project with two modules, an “app” module and a “commonUItest” module. The “app” module contains CommonUI library code. The “commonUItest” module is an Android project with a test harness, as well as sample layouts and usage of the components. Both are stored and committed in a software repository as often as they are altered, but only the “app” module is exported to a specific implementation of a Maven repository used by the developer for later access. The CommonUI library is exported as an .aar file, which means that all resources and strings contained within it are available for use in projects that reference it, in addition to the classes.

The blocks shown in FIGS. 1A and 1B are examples of parts that may comprise system 100 and do not limit the blocks or parts that may be connected to or associated with these parts. The blocks in FIGS. 1A and 1B may be implemented in software or hardware or a combination of the two, and may include memory for storing software instructions. Authentication protocols described above include username+password and FIDO/fingerprint, but other methods of authenticating users may be used. Moreover, as stated earlier, this block diagram can be applied to a system using an operating system other than Android. Application, activity, and fragment classes are generally files of code, as is module class 14. Other operating systems include libraries or modules similar to common UI components 17 and core services library 19.

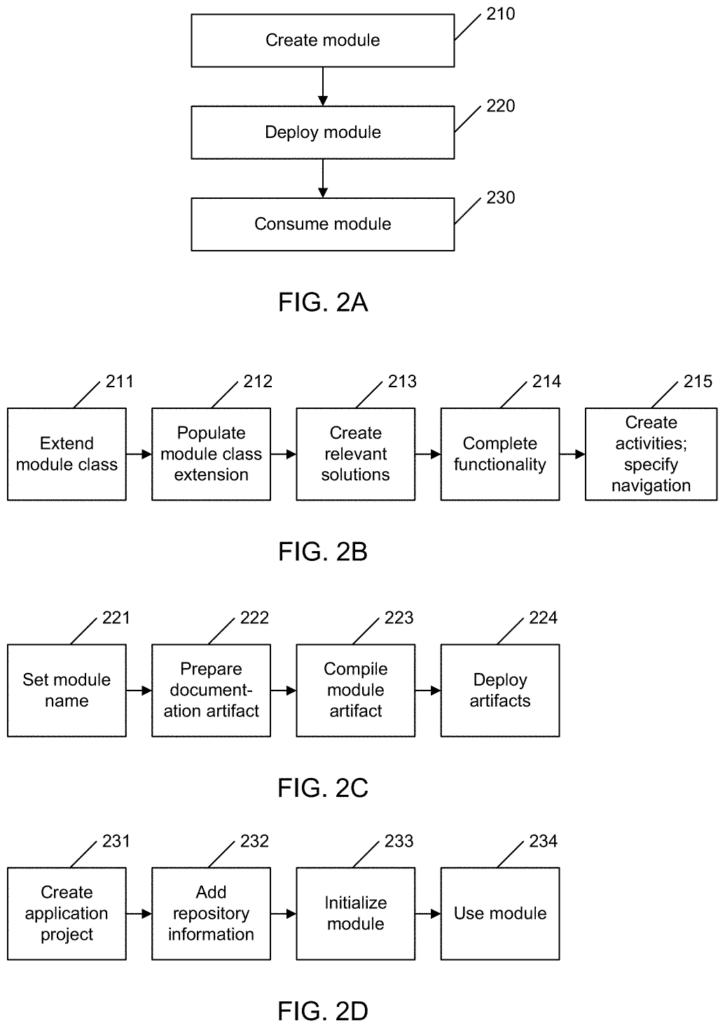

In order to generate a software application using AppBase 10 and software module 20, software module 20 needs to be created, published, and consumed, as shown in operations 210, 220, and 230 in FIG. 2A. As stated above, there are functional modules and activity modules. The operations are described using the Android operating system, but the concepts can be adapted to other operating systems. To create either type, AppBase 10 should be imported within a build.gradle file:

compile ‘com.mobile.base:App_Base:1.0’

AppBase 10 includes module class 14. The first part of creating a functional module is to create a public class that extends module class 14 to create a class that contains all of the information from module class 14 and adds more features to it. Extending this class is based on implementing certain methods, but it serves to register the software module with the generated software application when it is first produced and the software module will subsequently receive notifications from the software application when important events occur (such as a change in the device configuration). Functional modules do not provide their own navigation, so the related methods do not have to be overridden. “Navigation” is a way of specifying the user path through an application, or alternatively identifying the specific places in an app to which an end-user may go directly. “Overriding” is a standard Java/Android term/practice common throughout many programming languages, which means that an extending class can replace the contents of a method in the original class. The created public class defines public methods as appropriate, as well as any helper classes that are needed for module functionality.

Most software modules contain their own database. (A module that does not define or contain its own database would be incapable of storing complex data. Sometimes this is fine, such as with the CRM Module described above, which does not need to persist anything across application runs.) Managing the database at the module level allows independent database versioning when upgrading specific modules, as well as allowing different database implementations (e.g., SQLite/RealmDB) as appropriate for the task at hand. When defining the database name, package-specific naming should be used to prevent collision between module databases.

Creating an activity module includes first creating a module class as with the functional module, then building out activities and fragments that interact with that functional module class. This allows activity modules to define a UI and flow to be used when desired, but also allows software applications to interact directly with the data as additional functionality. Activity modules generally have a single activity entry point and handle internal navigation on their own (i.e., they should not require any application-specific navigation handling to work correctly). Some modules, such as the “Programs” and “Journal” modules, are more complex and have multiple entry points, stored data, and specific navigation paths. In such a case, each activity should be returned from the getNavigableItems( ) method in module class 14, which means that this specific method should return 0 to many specific entry points into the module that can be shown to the end-user for direct navigation.

Every Android activity and fragment contains a layout that dictates or defines how individual components should be placed on the screen when presented to the end-user. Layouts for AppBase Activities should not include toolbars, menus, or other application-level items. In AppBase, these are added by the application itself. When defining layouts and resources, the defining convention is “<moduleidentifier>_<resourcetype>_<resourcename>.” This prevents collision between module resources. Note, however, that this does not include the resources files themselves (strings.xml, etc.), but does include the resource names.

FIG. 2B depicts one way of creating a module. In general, the module should be set up with dependencies on AppBase 10. Additionally, dependencies on CoreServices, CommonUI, or other modules may be included. Modules will be released as fully functional entities ready to be consumed by an application, but will not be installable on devices on their own. As described above, module class 14 in AppBase 10 is extended in operation 211. Then the module class extension is populated with code specific and relevant to the module in operation 212. Next, data models, views and network/storage solutions relevant to the module are created in operation 213. In operation 214, utility and peripheral classes are created as necessary to complete the functionality of the module. Finally, in operation 215, activities are created and navigation points are specified to present functionality to the end-user.

The next step is to publish or deploy the module (functional or activity). Publishing is necessary—without sending the completed code to an accessible repository, other modules/applications would not be able to reference this module. A software module can be published directly from a local Android Studio, or from a continuous integration (CI) build process like Jenkins. CI is a common development practice to automatically create builds/artifacts for publishing when defined criteria are met. The following code (for the Gradle build system) can be used to publish a module to the Maven repository. Note that the GroupID can be shared, but the ArtifactID+Version combination must be unique in order to deploy successfully. ArtifactIDs should not be reused for modules with different purposes.

```
uploadArchives {
repositories {
mavenDeployer {
pom.groupId = ′com.mobile.module′
  pom.artifactId = ′Journal′
  pom.version = ′0.1.0′
snapshotRepository (url: mavenSnapshots) {
authentication (userName: repoUser, password: repoPassword)
}
repository (url: mavenReleases) {
authentication (userName: repoUser, password: repoPassword)
}
}
}
}
```

The convention for versioning is:

<major_version>.<minor_version>.<incremental_version>

where:
A major version number indicates a release with drastically different code, UI, or behavior. An app owner who moves up a major version should expect more stability and/or functionality, but should also expect to make changes to their code to accommodate the new version.
A minor version number indicates a change that adds a small amount of functionality, or otherwise changes existing functionality in a way that can/will break unaltered applications. About 50% of the time, an app owner should expect to make changes to their code when a minor version update occurs.
An incremental version could be a bug fix or patch, or a small amount of new functionality which is not immediately noticeable (like a new method in a utility class). Incremental versions should not require application updates, and should not be a cause for breakage. If things like method signatures are being altered without handling for backward compatibility, a minor version number increase should be used instead.

Filenames also have conventions defined, depending on the use and type, to prevent future collision of resource or activity names. This is especially important when dealing with resources, because the Android System will overload/replace identically named items automatically.

Resources: <moduleidentifier>_<resourcetype>_<resourcename>
Where: moduleidentifier is a short, unique character sequence. New modules should ensure that the identifier chosen is not already in use by an existing module;
   resourcetype is the type of the resource, such as “icon”, “img”, or “color”; and
   resourcename is the specific name of the resource. This can be multiple parts and should be as specific as is necessary to allow easy identification.
      An example of a Resource name for the Journal Module is “journal_color_dashboard_background,” which uses “journal” as the moduleidentifier, “color” as the resourcetype, and “dashboard_background” as the name of the background color or image to use on a dashboard screen. Activities and Fragments should begin with a short/common name for the module. For instance, the Journal Module's main activity that displays all journal entries is called “JournalListActivity.” Since the full package identifier can be used, this is more of a courtesy for consuming developers.

Modules may be modified, but this should be done using a protocol. To modify an existing module, the module developer opens up the existing codebase in an integrated development environment (IDE). By convention, when using GIT, the latest version of the code should exist under the MASTER branch, but this may vary from module to module. Next, the module developer creates a new branch within this codebase to keep the new code separated until it is completed. A module may contain a standard test harness within its codebase for manually testing the different activities and functionalities provided by the module. This test harness is not a part of the module artifact, but exists solely for development purposes within the codebase. (If the module developer adds new functionality to the module, the developer should also add corresponding test code to the test harness.)

If the changes made to the module are small and/or completely testable with the test harness, the module can be released. The new code should be committed and merged with the main codebase branch before release. If the changes made to the module require more testing than the test harness can provide, the module developer can “sideload” the module code with an existing application (e.g., App 1 in FIG. 1A) using the following steps (that are specific to Android Studio):
The following should be added to the App 1 settings.gradle:

include ‘:<modulename>’ (where “modulename” is the name of the module that is being modified)

project(‘:<modulename>’).projectDir=new

### File(‘<path_to_module_code_directory_on_developer's_machine>’)

And the following should be added to the App 1 build.gradle file to reference the local copy of the module being modified instead of the previous (artifact) version: //compile ‘<artifact>’ compile project(‘:<modulename>’)
   Now when App 1 is compiled, it will be using the local version of the Module so that changes to the Module can be tested. Once the testing is completed, these configuration changes to the App 1 codebase should be reversed.

FIG. 2C depicts one way of publishing or deploying a module to an accessible repository. The details and location of this repository will differ between embodiments, so this process shows the packaging process. In operation 221, the module name and information number, including the version number, is set in the build system file (build.gradle on Android). In operation 222, if desired, a code documentation artifact such as Javadoc may be prepared. This artifact may be released alongside the consumable module artifact (“.aar” in Android) built/compiled in operation 223. Then, in operation 224, the consumable artifacts may be released or deployed to an artifact repository, such as Maven.

Once the module is published or deployed, it can be used. This will vary based on the current software application as well as the specific module to be used. Here are a few of the most common use cases. For a software application to use a functional module, the library should be referenced from its build.gradle settings:

compile ‘com.module.wearable:SEIWearables:1.0’

Once included as a dependency, the module methods can be called as if they are part of the software app:

new WearableDeviceModule (this)

For a software application to use an activity module, the application must first be built on top of AppBase 10, which defines a base activity and fragment. AppBase 10 also assists with Android M permissions and navigation destinations in a centralized manner. By using AppBase 10 as the root of both the software application and the software modules, the two can work with each other seamlessly with a minimal number of callbacks or compatibility issues.

compile ‘com.mobile.base:App_Base:1.0’

After building the software application on AppBase 10 (including using Application Class Extension 11 for the app), an activity module can be used by referencing it from the Maven repository, and calling its activity/activities:

compile ‘com.mobile.module:Journal:1.0’

new Intent (getContext( ) JournalActivity.class)

Once a module has been released, it is available for consumption from the hosting repository. FIG. 2D depicts one way to consume or use a module. In operation 231, an AppBase application project is created. In operation 232, repository information is added to the build system, and the module name+version is added to the dependency list (both of which are within build.gradle in Android). In operation 233, at boot, or at first desired use, the module is initialized with any required information. This may be a call to .initialize( ) or a similar method within the module class extension, passing the application's context. In some cases, other configurations are passed as well. Finally, in operation 234, the module is ready for use.

Besides the operations shown in FIGS. 2A-2D, other operations or series of operations may be used to generate a software module. For example, operations were described using Gradle as a build system to configure AppBase. Android (and many systems) use Gradle to control builds, but there are other build systems as well which can similarly configure AppBase. Moreover, the actual order of the operations in the flowchart may not be critical.

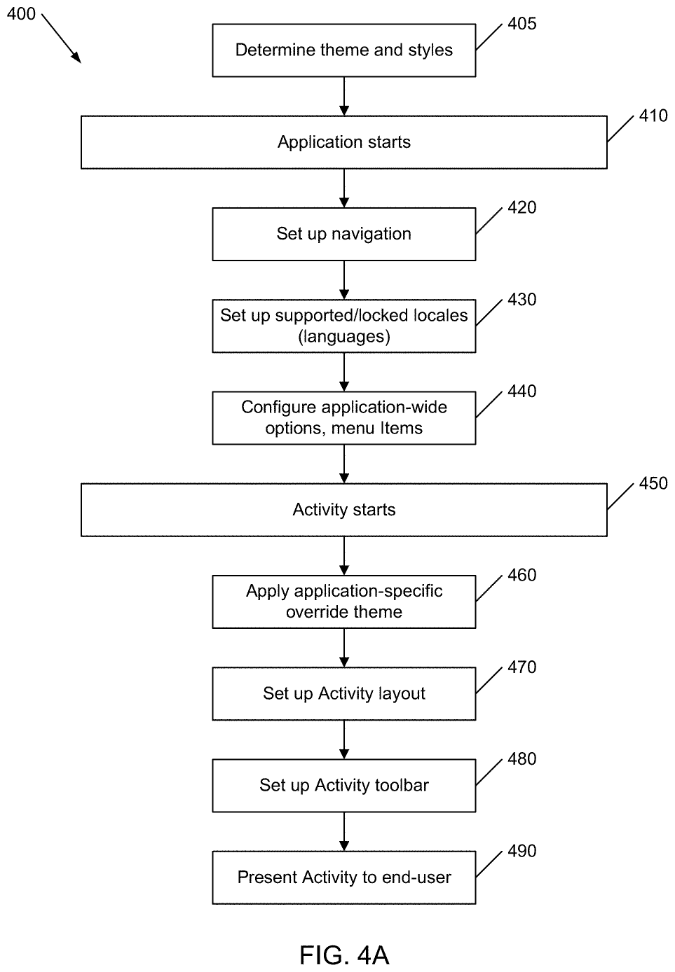

Reference is now made to FIG. 3, which is a flowchart 300 illustrating the operations used to generate a software application, according to the exemplary embodiment discussed above. As before, the operations are described using the Android operating system, but the concepts can be adapted to other operating systems.

In operation 305, the software application must specify Application Class Extension 11 (or a descendant) in its AndroidManifest.xml. If the software application already has its own class, then Application Class Extension 11 may be extended rather than using the basic android Application. This helps control navigation, because this is the only place common to both application code and modules, so lacking Application Class Extension 11 would result in an inconsistent experience throughout an app. The application class is specified in AndroidManifest.xml as:

```
<application
  android:name=″com.mobile.base.ApplicationClassExtension″
  android:theme=″@style/AppBaseTheme″ . . . >
```

Application Class Extension 11 controls locale-locking (optional via config.xml), navigation, user login/logout, and module management. Navigation (and the activities that may be navigated to) do not exist by default; navigation defined in software modules may be added automatically for reference, but does not become the main navigation of an application unless set. Navigation is turned OFF by default as a safety measure (to ensure the class is being used); to turn it on, the following should be added to the extended Application Class Extension:

@Override
public boolean appUsesNavigation( ){return true;}
   To provide the list of navigable activities to the software application, the getNavigationList( ) method in the extended application class extension class must be overridden.

In operation 310, the software application must specify in AndroidManifest.xml Theme 15 or an extension as its theme (the syntax is shown in the above paragraph). Theme 15 sets some standards that can be overridden as appropriate in the software applications. Typically, apps will customize their theme by defining the AppBase Theme as the “parent” and replacing values as required. If a different theme is used in the application (or Theme 15 is reset), the software application must use an AppCompat theme with no action bar (the top area on an Android screen that contains title and other common elements), and must provide its own custom attributes, including menu background, menu item background, menu icon color, menu item text appearance, toolbar theme, toolbar pop-up theme, tab text color, tab selected text color, toolbar icon color, toolbar home icon, toolbar home left margin, and toolbar title left margin. (AppCompat is a set of support libraries that may be used to make apps developed with newer Android versions operate with older Android versions.)

In operation 315, the software application's activities must extend Activity Class Extension 12. Activity Class Extension 12 provides standardized layout and navigation handling that apply to all applications and activity modules.

In operation 320, it is best if the application fragments in the software application extend Fragment Class Extension 13. Fragment Class Extension 13 provides some helpful methods to app owners, but not all apps will use fragments and not all fragments will have use for those methods. It is still recommended to extend Fragment Class Extension 13 to allow for future support.

In operation 325, user management should be handled through the logInUser(user) and logOutUser( ) calls on Application Class Extension 11 (accessible via the app( ) convenience method). (App( ) is a reference to the current instance of Application Class Extension 11 from the current Activity Class Extension 12 or Fragment Class Extension 13; it is a convenience method, since typically there are several steps to obtain the application reference from an activity or fragment.) This allows both the app and any module to access the current user ID at any time via the command app( ) getUserId( ). This is noteworthy, because many modules will use the UserID as the key to the storage methodology for the modules.

Besides the operations shown in FIG. 3, other operations or series of operations may be used to generate a software application. Moreover, the actual order of the operations in the flowchart may not be critical.

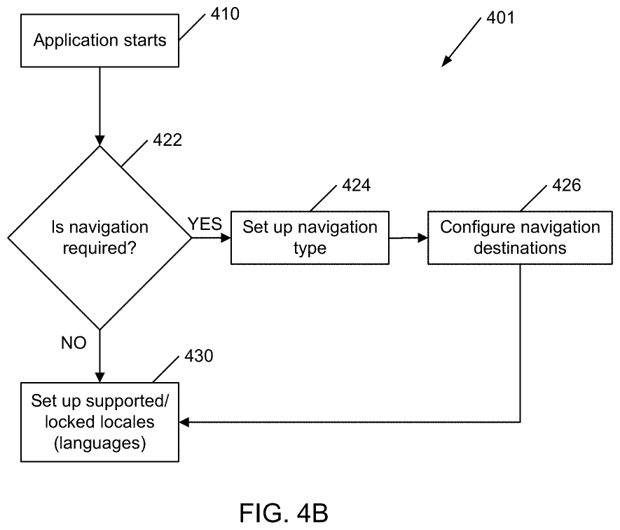

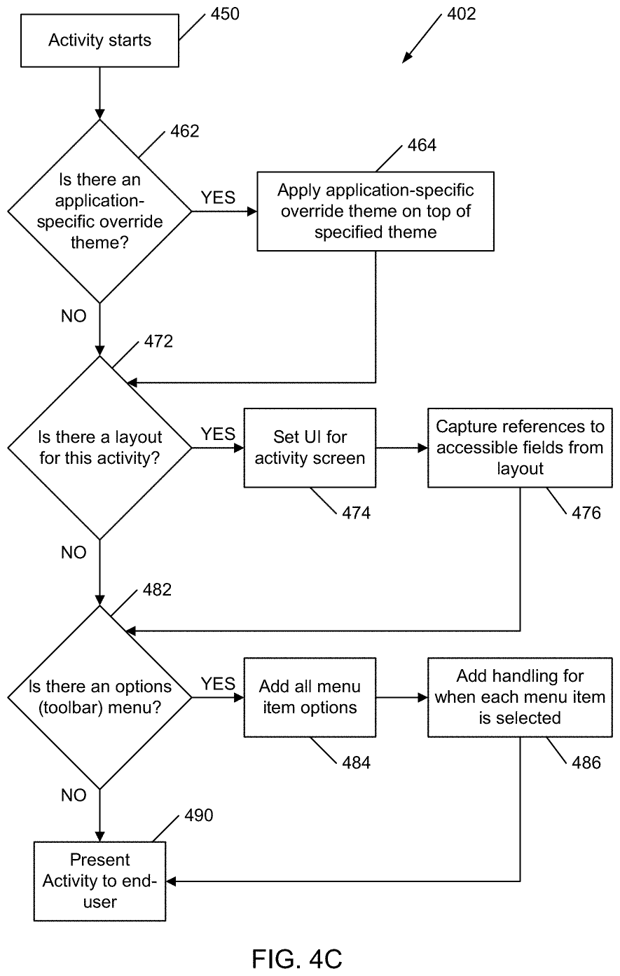

Reference is now made to FIGS. 4A-4C, which show flowcharts 400, 401, and 402 illustrating the operations used to generate a software application, according to an embodiment of the present invention. As before, the operations are described using the Android operating system, but the concepts can be adapted to other operating systems.

The app owner first determines the theme and styles for the app. In a conventional app, the standard Android theme elements, defined by the operating system, may be configured via XML by the application. In operation 405, in addition to the standard elements, AppBase 10 defines additional theme items for applications to configure via XML by the application. Themes are handled at the base level, which is common to all applications 30 and modules 20 built on AppBase 10, which means the specified theme(s) apply to every visible activity and fragment, presenting a seamless experience to the end-user.

In operation 410, the Application starts. In operation 420, navigation may be set up, as shown in more detail in flowchart 401 in FIG. 4B. Operation 422 asks whether navigation is required. If so, navigation type is set up in operation 424 and navigation destinations are configured by the Application in operation 426 and referenced from the AppBase base activity class. In this way, navigation is automatically set up for each individual activity as soon as it is created, and all modules built on AppBase 10 (and therefore using the same common base class) can be used within any app built on AppBase 10, and thus the same user experience will be presented throughout.

This navigation setup differs from prior methods. Here, navigation is configured by the Application, whereas the prior method was configured by the Activity (and thus occurred later in the flow). In the prior method, each Activity explicitly loaded the destinations and handling—usually from a common utility method—because the Activity UI includes the layout information, which needed to be present before the setup could continue. (A common utility method is a typical development approach for navigation and other use cases in which a single method is created in the codebase and is subsequently called by every activity.) In turn, this meant that all Activities needed access to all of the destination/handling data and/or the common utility method, which precluded third-party libraries from being able to present an identical user experience.

Next, in operation 430, supported/locked locales (languages) may be set up. AppBase 10 adds the ability for app-configured locale locking. AppBase 10 contains XML configurations for supported languages and default language, which allows an app to identify a specific set of locale content that may be used. In this way, apps that include modules that may have different sets of content available can prevent the sometimes-available content from being used, and present the end-user with a single-language experience.

This locale ability differs from the standard Android capability, which allows for content to be provided in any number of languages, and the end-user's device locale will determine which content set will be used. If a matching set is available, that content will be loaded; if not, the main set (typically US English) will be used. When using third-party libraries, this can result in different sections of the application rendering content in different languages (as available).

After setting up the locales, operation 440 adds and configures any application-wide options and menu items. Similar to navigation, an Application can configure toolbar items to be automatically placed on all activities. This differs from the standard Android situation in which each activity sets up and configures its own toolbar menu, and if toolbar items are common across multiple activities, each activity must set those items up individually. Later, in operations 480-486, each activity may add its own custom items to the toolbar menu so that the experience to the end-user will be seamless throughout the app, while still allowing for specific actions to be taken within activities.

Next, in operation 450, the Activity starts. Under this Activity section, operation 460 will apply an application-specific override theme if available, operation 470 will set up the Activity layout, and operation 480 will set up the Activity toolbar. These tasks are shown in more detail in flowchart 402 in FIG. 4C.

Operation 462 asks whether there is an application-specific override theme. AppBase 10 adds the ability to override the application theme at runtime, allowing for customized user experiences based on real-time data. Since this is handled in the basic class, the override theme (as with the standard theme set up in operation 405) applies to all modules to present a seamless experience to the end-user. This differs from standard Android, which has no concept of an app-wide theme override—only the compile-time configured themes are used. If there is an application-specific override theme, that theme is applied in operation 464 on top of the theme from operation 405.

Operation 472 asks whether there is a layout for this activity. If so, operation 474 sets the UI for the activity screen and operation 476 captures references to accessible fields from the layout. With an application built on AppBase 10, the Activity UI is concerned only about its specific content —the toolbars, navigation anchors, and other “app-level” considerations are left to the platform (see operations 424 and 440). This differs from the standard Android case, in which the Activity UI would include the entire renderable screen, including toolbars, navigation anchors, etc.

Operation 482 asks whether there is an options or toolbar menu for the activity. If so, operation 484 adds all menu item options (as discussed above in relation to operation 440), and operation 486 adds handling for when each menu item is selected. After the override theme, layout, and options menu are selected, the activity is presented to the end-user in operation 490.

Besides the operations shown in FIGS. 4A-4C, other operations or series of operations may be used to generate a software module. Moreover, the actual order of the operations in the flowchart may not be critical.

Accordingly, a system and method for generating a software application are provided that provide standardization of design and implementation across a family of software applications, allow discrete, standalone pieces of functionality to be written once and used across multiple software applications, and allow service reuse according to functionality, eliminating the need to clone service layers for different software applications. The aspects that differentiate this approach and help overcome some of the limitations of prior methods include having an application codebase with extensions to the Application, Activity, and Fragment classes, as well as a module class and a theme. This application codebase underlies the theme and styles for an application, allows navigation to be configured by the Application, rather than by the Activity, and sets up locales and languages configured by the app. Having a common application codebase on which modules are built, when a module is updated, that update may be distributed to each application that uses the module, thus reducing the workload of the application owner.

Although embodiments of the present invention have been described in terms of software applications for Android mobile devices, other embodiments of the present invention may involve networked, standalone, single use, and/or single tenant software packages that may be presented to an end-user on a CD, a DVD, or a floppy disk, or via download to a standalone computer or device.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon. For example, the computer-readable medium may be a computer-readable storage medium, which may be, for example, an electronic, optical, magnetic, electromagnetic, infrared, or semiconductor system, apparatus, or device, or any combination thereof.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system for authoring a software application, the system comprising:
an application codebase, comprising an application class extension, an activity class extension, a theme, and a module class, for generating a software module to be incorporated into the software application,
wherein the software module extends the module class; and
wherein the software application comprises at least one activity and:
the software application specifies the application class extension that is common to the software module;
the software application specifies the theme; and
the activity of the software application extends the activity class extension.

2. The system of claim 1, wherein the software module accesses a core services library and a common user interface module.

3. The system of claim 1, wherein the application codebase comprises a fragment class extension, the software application comprises a fragment, and the software application's fragment extends the fragment class extension.

4. The system of claim 1, wherein the software application comprises at least two software modules built on the application codebase.

5. The system of claim 1, wherein an update to the software module is released to a software repository and the software application is updated by consuming the changes to the software module.

6. A method for authoring a software application, the method comprising:
generating a software module using an application codebase comprising an application class extension, an activity class extension, a theme, and a module class, wherein said generating comprises extending the module class;
specifying, by the software application, the application class extension that is common to the software module;
specifying, by the software application, the theme; and
specifying, by the software application, an activity to extend the activity class extension.

7. The method of claim 6, wherein the software module accesses a core services library and a common user interface module.

8. The method of claim 6, wherein the application codebase comprises a fragment class extension, the software application comprises a fragment, and the software application's fragment extends the fragment class extension.

9. The method of claim 6, wherein the software application comprises at least two software modules built on the application codebase.

10. The method of claim 6, further comprising:
releasing an update to the software module to a software repository; and
updating the software application by consuming the changes to the software module.
